(19) United States
(12) Patent Application Publication
(10) Pub. No.: US 2011/0072473 A1
(43) Pub. Date: Mar. 24, 2011

(54) ADAPTER DEVICE FOR WIRELESSLY TRANSMITTING VIDEO SIGNAL FROM SOURCE DEVICE TO ADAPTER DEVICE FOR SINK DEVICE

(76) Inventors: Makoto Funabiki, Osaka (JP); Akihiro Tatsuta, Kyoto (JP); Hiroshi Ohue, Osaka (JP)

(21) Appl. No.: 12/991,761

(22) PCT Filed: May 19, 2009
(86) PCT No.: PCT/JP2009/002200

§ 371 Date: Nov. 9, 2010

(30) Foreign Application Priority Data
May 20, 2008 (JP) 2008-131656

(51) Int. Cl. H04N 7/18

(52) U.S. Cl. 725/81

(57) ABSTRACT

An adapter device connected to a source device wirelessly receives an EDID response message signal including data on a plurality of video display formats and a plurality of audio output formats of the sink device from an adapter device. Further, the adapter device selects one video display format having highest data transmission rate and one audio output format having highest data transmission rate based on received data on the video display formats and the audio output formats, and reserves a band for wirelessly transmitting a video signal having a selected video display format and an audio signal having a selected audio output format as a band for wirelessly transmitting an audio and visual signal from the source device

### TECHNICAL FIELD

The present invention relates to an adapter device for use in a source device, and a wireless communication method provided for the adapter device for the source device. In particular, the present invention relates to an adapter device for use in a source device for wirelessly transmitting a video signal outputted from the source device such as a DVD player or a set-top box to a sink device such as a digital television, and a method of controlling the adapter device for use in the source device.

### BACKGROUND ART

A DVI (Digital Visual Interface) is known as an interface standard for transmitting a video signal from a source device such as a DVD player to a sink device such as a plasma display device (referred to as a PDP device hereinafter). In addition, an HDMI (High Definition Multimedia Interface) for transmitting a video signal and an audio signal using one cable has been developed (See Non Patent Document 1) as an interface standard extended from the DVI for next-generation digital television, and AV devices adopting the HDMI begin to penetrate the market.

According to the HDMI, the source device includes a transmitter circuit, the sink device includes a receiver circuit and an EDID (Extended Display Identification Data) memory, and the source device is connected to the sink device via an HDMI cable, which is a digital data transmission bus compliant with the HDMI. In addition, according to the DVI, the source device is connected to the sink device via a DVI cable, which is a digital data transmission bus compliant with the DVI. In this case, the EDID memory previously stores therein EDID data, which is configuration information including identification information of the sink device and a plurality of video display formats and a plurality of audio output formats of the sink device. Each of the HDMI cable and the DVI cable includes a TMDS (Transition Minimized Differential Signaling) channel and a DDC (Display Data Channel) channel. The source device reads out the EDID data on the sink device via the DDC channel.

According to the HDMI, the source device selects one video display format and one audio output format from among a plurality of video display formats and a plurality of audio output formats of the sink device read-out from the EDID data, respectively. Further, the source device generates a baseband video signal having a selected video output signal, a digital audio signal having a selected audio output signal, and auxiliary data, and transmits the baseband video signal, the digital audio signal, and the auxiliary data to the sink device via the TMDS channel together with data on the video display format and data on the audio output format.

In addition, according to the DVI, the source device reads out the EDID on the sink device via the DDC channel, and thereafter, selects one video display format from among a plurality of video display formats on the sink device read-out from the EDID. Further, the source device generates a baseband video signal having the selected video output signal, and transmits the baseband video signal together with data on the video display format to the sink device via the TDMS channel.

Further, in a video data wireless transmission system according to a prior art as described in Patent Document 1, the source device generates a wireless signal including the video signal transmitted via the TMDS channel, and wirelessly transmits the wireless signal to the sink device using a certain frequency band.

### CITATION LIST

### Patent Document

Patent Document 1: Japanese patent laid-open publication No. JP-2007-511977-A.

### Non Patent Document

Non Patent Document 1: “High-Definition Multimedia Interface Specification, Version 1.3a”, HDMI Licensing, LLC, California in USA, Nov. 10, 2006.

### SUMMARY OF INVENTION

### Technical Problem

In the video data wireless transmission system according to the prior art, a band having a data transmission rate higher than a data transmission rate actually required is allocated for wireless transmission of the video signal, so as to wirelessly transmit the video signal with certainty. Therefore, there was such a problem that the video signal cannot be wirelessly transmitted efficiently.

It is an object of the present invention to provide an adapter device for use in a source device and method of controlling the adapter device for use in the source device each capable of solving the above-mentioned problem, and being capable of wirelessly transmitting a video signal received from the source device more efficiently as compared with the prior art.

### Solution to Problem

According to the first aspect of the present invention, there is provided an adapter device for a source device for use in a wireless communication system. The wireless communication system includes the adapter device for the source device wirely connected to the source device, and an adapter device for a sink device wirely connected to the sink device. The adapter device for the source device wirelessly transmits a transmitting signal including a video signal from the source device in a predetermined band. The sink device stores therein data on a plurality of video display formats. The adapter device for the sink device wirelessly receives the transmitting signal, and outputs the video signal included in a wirelessly received transmitting signal to display means of the sink device so as to display the video signal. The adapter device for the source device includes controller means for wirelessly receiving a format notification signal including the data on the plurality of video display formats of the sink device from the adapter device for the sink device. The controller means selects one video display format having highest data transmission rate based on the data on the plurality of video display formats, and reserves a band for wirelessly transmitting a video signal having a selected video display format as the predetermined band.

In the above-mentioned adapter device for the source device, the controller means calculates data transmission rates for wirelessly transmitting video signals having the plurality of video display formats based on the data on the video display formats, respectively, and selects the video display format having the highest data transmission rate based on calculated data transmission rates.

In addition, the above-mentioned adapter device for the source device further includes storage means for previously storing therein a band management table for storing therein the video display formats and the data transmission rates for wirelessly transmitting the video signals having the video display formats with establishing a correspondence between the video display formats and the data transmission rates for wirelessly transmitting the video signals having the video display formats. The controller means selects the video display format having the highest data transmission rate with reference to the band management table.

Further, the above-mentioned adapter device for the source device further includes storage means for previously storing therein a band management table for storing therein the video display formats and priorities representing the data transmission rates for wirelessly transmitting the video signals having the video display formats with establishing a correspondence between the video display formats and the priorities. The controller means selects the video display format having highest priority as the video display format having the highest data transmission rate with reference to the band management table.

Still further, in the above-mentioned adapter device for the source device, the band management table further stores therein band reservation parameters for reserving bands for wirelessly transmitting the video signals having the video display formats with establishing a correspondence between the video display formats and the band reservation parameters. The controller means reserves the band for wirelessly transmitting the video signal having the selected video display format as the predetermined band using a band reservation parameter corresponding to the selected video display format with reference to the band management table.

In addition, in the above-mentioned adapter device for the source device, the band for wirelessly transmitting the video signal having the selected video display format includes repetition of a plurality of reservation periods. Each of the band reservation parameters includes at least a time width of each of the reservation periods, a time interval of each of the reservation periods, and a repetition number of the reservation periods.

Further, in the above-mentioned adapter device for the source device, the transmitting signal includes the video display format of the video signal included in the transmitting signal. When a video display format of the video signal included in the transmitting signal is different from the selected video display format, the controller means releases a reserved predetermined band, and reserves a band for wirelessly transmitting the video signal included in the transmitting signal as the predetermined band.

Still further, in the above-mentioned adapter device for the source device, the format notification signal includes EDID data including the data on the plurality of video display formats of the sink device.

In addition, in the above-mentioned adapter device for the source device, the transmitting signal further includes an audio signal from the source device, the sink device further stores therein data on a plurality of audio output formats, and the adapter device for the sink device outputs the audio signal included in the transmitting signal to the sink device. The format notification signal further includes the data on the plurality of audio output formats of the sink device. The controller means selects one audio output format having highest data transmission rate based on the data on the plurality of audio output formats, and reserves a band for wirelessly transmitting the video signal having the selected video display format and an audio signal having the selected audio output format as the predetermined band.

Further, in the above-mentioned adapter device for the source device, upon receiving a transmittable-or-not notification signal representing that the source device can transmit the transmitting signal from the source device, the controller means reserves the predetermined band.

Still further, in the above-mentioned adapter device for the source device, upon wirelessly receiving a receivable-or-not notification signal representing that the sink device can receive the transmitting signal from the adapter device for the sink device, the controller means reserves the predetermined band.

In addition, in the above-mentioned adapter device for the source device, upon receiving a transmittable-or-not notification signal representing that the source device cannot transmit the transmitting signal from the source device, the controller means releases the reserved predetermined band.

Further, in the above-mentioned adapter device for the source device, upon wirelessly receiving a receivable-or-not notification signal representing that the sink device cannot receive the transmitting signal from the adapter device for the sink device, the controller means releases the reserved predetermined band.

According to the second aspect of the present invention, there is provided a method of controlling an adapter device for a source device for use in a wireless communication system. The wireless communication system includes the adapter device for the source device wirely connected to the source device, and an adapter device for a sink device wirely connected to the sink device. The adapter device for the source device wirelessly transmits a transmitting signal including a video signal from the source device in a predetermined band. The adapter device for the sink device wirelessly receives the transmitting signal, and outputs the video signal included in a wirelessly received transmitting signal to display means of the sink device so as to display the video signal. The method includes a control step of wirelessly receiving a format notification signal including the data on the plurality of video display formats of the sink device from the adapter device for the sink device, selecting one video display format having highest data transmission rate based on the data on the plurality of video display formats, and reserving a band for wirelessly transmitting a video signal having a selected video display format as the predetermined band.

In the above-mentioned method of controlling the adapter device for the source device, the control step includes calculating data transmission rates for wirelessly transmitting video signals having the plurality of video display formats based on the data on the video display formats, respectively, and selecting the video display format having the highest data transmission rate based on calculated data transmission rates.

In addition, the above-mentioned method of controlling the adapter device for the source device further including a step of previously storing a band management table in storage means. The band management table stores the video display formats and the data transmission rates for wirelessly transmitting the video signals having the video display formats with establishing a correspondence between the video display formats and the data transmission rates for wirelessly transmitting the video signals having the video display formats. The control step includes selecting the video display format having the highest data transmission rate with reference to the band management table.

Further, the above-mentioned method of controlling the adapter device for the source device further includes a step of previously storing a band management table in storage means. The band management table stores the video display formats and priorities representing the data transmission rates for wirelessly transmitting the video signals having the video display formats with establishing a correspondence between the video display formats and the priorities. The control step includes selecting the video display format having highest priority as the video display format having the highest data transmission rate with reference to the band management table.

Still further, in the above-mentioned method of controlling the adapter device for the source device, the band management table further stores therein band reservation parameters for reserving bands for wirelessly transmitting the video signals having the video display formats with establishing a correspondence between the video display formats and the band reservation parameters. The control step includes reserving the band for wirelessly transmitting the video signal having the selected video display format as the predetermined band using a band reservation parameter corresponding to the selected video display format with reference to the band management table.

In addition, in the above-mentioned method of controlling the adapter device for the source device, the band for wirelessly transmitting the video signal having the selected video display format includes repetition of a plurality of reservation periods. Each of the band reservation parameters includes at least a time width of each of the reservation periods, a time interval of each of the reservation periods, and a repetition number of the reservation periods.

Further, in the above-mentioned method of controlling the adapter device for the source device, the transmitting signal includes the video display format of the video signal included in the transmitting signal. The control step includes releasing a reserved predetermined band, and reserving a band for wirelessly transmitting the video signal included in the transmitting signal as the predetermined band, when a video display format of the video signal included in the transmitting signal is different from the selected video display format.

In addition, in the above-mentioned method of controlling the adapter device for the source device, the format notification signal includes EDID data including the data on the plurality of video display formats of the sink device.

Further in the above-mentioned method of controlling the adapter device for the source device, the transmitting signal further includes an audio signal from the source device, the sink device further stores therein data on a plurality of audio output formats, and the adapter device for the sink device outputs the audio signal included in the transmitting signal to the sink device. The format notification signal further includes the data on the plurality of audio output formats of the sink device. The control step includes selecting one audio output format having highest data transmission rate based on the data on the plurality of audio output formats, and reserving a band for wirelessly transmitting the video signal having the selected video display format and an audio signal having the selected audio output format as the predetermined band.

### Advantageous Effects of Invention

According to the adapter device for use in the source device and the method of controlling the adapter device for use in the source device according to the present invention, the format notification signal including the data on the plurality of video display formats stored in the sink device is wirelessly received from the adapter device for the sink device, one video display format having the highest data transmission rate is selected based on the data on the plurality of video display formats, and the band for wirelessly transmitting the video signal having the selected video display format is reserved as the predetermined band. Therefore, it is possible to wirelessly transmit the video signal received from the source device more efficiently as compared with the prior art.

### BRIEF DESCRIPTION OF DRAWINGS

FIG. 1 is a block diagram showing a configuration of a wireless communication system according to a first embodiment of the present invention including a source device 10, adapter devices 20 and 30, and a sink device 40.

FIG. 2 is a block diagram showing respective configurations of the source device 10 and the adapter device 20 of FIG. 1.

FIG. 3 is a block diagram showing respective configurations of the adapter device 30 and the sink device 40 of FIG. 1.

FIG. 4 is a sequence diagram showing an audio and visual signal transmitting process executed by the wireless communication system of FIG. 1.

FIG. 5 is a diagram showing an example of a format of an EDID request message included in an EDID request message signal of FIG. 4.

FIG. 6 is a diagram showing an example of a format of an EDID response message included in an EDID response message signal of FIG. 4.

FIG. 7 is a flowchart showing a band reservation process of step S2 of FIG. 4, the band reservation process which is executed by a controller 21 of the adapter device 20 of FIG. 2.

FIG. 8 is a flowchart showing a band change process of step S3 of FIG. 4, the band change process which is executed by the controller 21 of the adapter device 20 of FIG. 2.

FIG. 9 is a flowchart showing a band release process which is executed by the controller 21 of the adapter device 20 of FIG. 2.

FIG. 10 is a block diagram showing respective configurations of an adapter device 20A and a source device 10 according to a second embodiment of the present invention.

FIG. 11 is a table showing a video signal band management table stored in a table memory 26 of FIG. 10.

FIG. 12 is a table showing a video signal band management table according to a modified embodiment of the second embodiment of the present invention.

### DESCRIPTION OF EMBODIMENTS

Preferred embodiments according to the present invention will be described below with reference to the attached drawings. Components similar to each other are denoted by the same reference numerals and will not be described herein in detail.

### First Embodiment

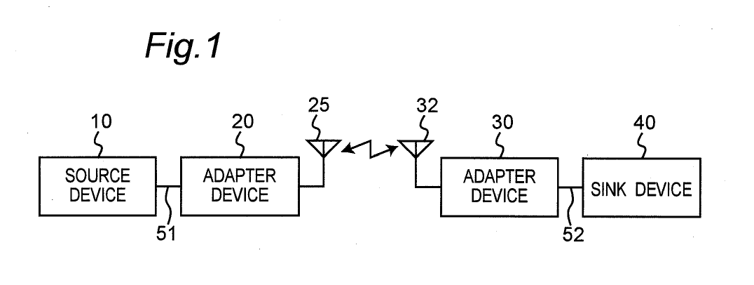

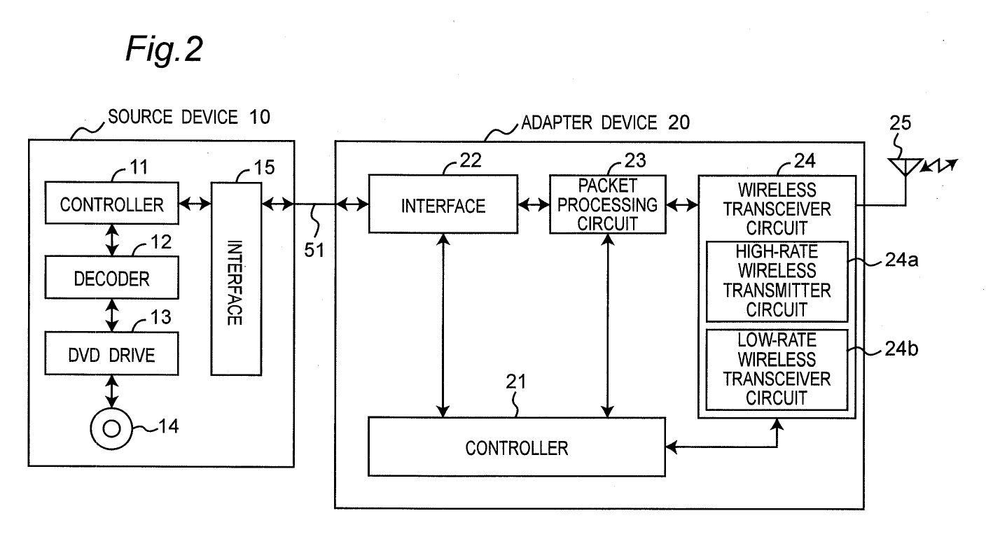

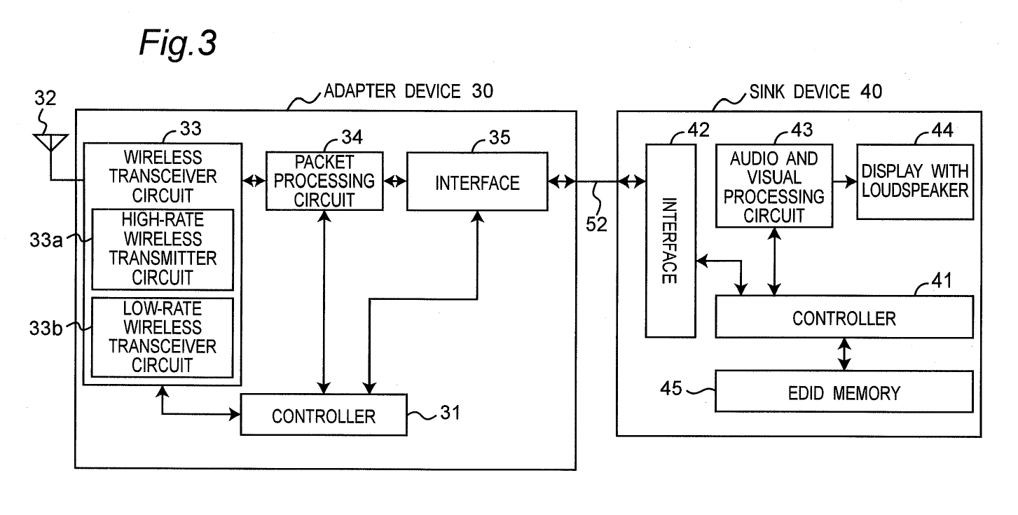

FIG. 1 is a block diagram showing a configuration of a wireless communication system according to a first embodiment of the present invention including a source device 10, adapter devices 20 and 30, and a sink device 40. In addition, FIG. 2 is a block diagram showing respective configurations of the source device 10 and the adapter device 20 of FIG. 1, and FIG. 3 is a block diagram showing respective configurations of the adapter device 30 and the sink device 40 of FIG. 1.

Referring to FIG. 1, the wireless communication system according to the present embodiment includes the source device 10 of a DVD player, the adapter device 20 for use in the source device (referred to as the adapter device 20 hereinafter) including an antenna 25, the adapter device 30 for use in the sink device (referred to as the adapter device 30 hereinafter) including an antenna 32, and the sink device 40 of a PDP (Plasma Display Panel) device. The source device 10 is a signal source device for transmitting and receiving signals compliant with the HDMI, and connected to the adapter device 20 via an HDMI cable 51, which is a digital data transmission bus compliant with the HDMI. Further, the adapter device 20 and the adapter device 30 are wirelessly connected to each other via the antennas 25 and 32. Further, the sink device 40 is a signal sink device which stores EDID data including data on a plurality of video display formats and a plurality of audio output formats, and transmits and receives the signals compliant with the HDMI. The sink device 40 is connected to the adapter device 30 via an HDMI cable 52, which is a digital data transmission bus compliant with the HDMI. As described later in detail, in the wireless communication system of FIG. 1, the source device 10 and the sink device 40 transmit and receive various signals based on the HDMI via the adapter devices 20 and 30. In particular, as described later in detail, the adapter device 20 wirelessly transmits a transmitting signal including an audio and visual signal outputted from the source device 10, to the adapter device 30 in a predetermined band. The adapter device 30 wirelessly receives the transmitting signal, and outputs the audio and visual signal included in a wirelessly received transmitting signal to a display with a loudspeaker 44 of the sink device 30.

Referring to FIG. 1, each of the HDMI cables 51 and 52 includes a plurality of audio and visual signal lines for transmitting an audio and visual signal, a 5V-voltage signal line for transmitting a 5V-voltage signal (+5V Power signal), an HPD (Hot Plug Detect) signal line for transmitting an HPD signal, and a DDC (Display Data Channel) signal line for transmitting a DDC signal.

In this case, the 5V-voltage signal is defined in the HDMI and the DVI. The 5V-voltage signal is a transmittable-or-not notification signal representing whether or not the source device can transmit an audio and visual signal (a video signal in the case of the DVI) to the sink device. The source device generates a low-level 5V-voltage signal representing that the source device cannot transmit the audio and visual signal, and outputs the low-level 5V-voltage signal to the sink device, by setting a voltage level of the 5V-voltage signal included in the HDMI cable or DVI cable to 0V. The source device generates a high-level 5V-voltage signal representing that the source device can transmit the audio and visual signal, and outputs the high-level 5V-voltage signal to the sink device, by changing the voltage level of the 5V-voltage signal line from 0V to 5V.

In addition, the HPD signal is defined in the HDMI and the DVI. The HPD signal is a receivable-or-not notification signal representing whether or not the sink device can receive the audio and visual signal (video signal according to the DVI) from the source device. The sink device generates an HPD signal representing that the sink device cannot receive the audio and visual signal, and outputs the HPD signal to the source device by setting a voltage level of the HPD signal line included in the HDMI cable or DVI cable to a low level. The sink device generates an HPD signal representing that the sink device can receive the audio and visual signal, and outputs the HPD signal to the source device, by changing the voltage level of the HPD signal line from the low level to a high level.

Referring to FIG. 2, the source device 10 is configured to include a controller 11, a decoder 12, a DVD drive 13, a DVD 14, and an interface 15. The controller 11 controls overall operation executed by the source device 10. In addition, the interface 15 executes an interface process for interfacing with the adapter device 20 on a signal inputted from the controller 11, generates a signal compliant with the HDMI, and outputs a generated signal to the adapter device 20 via the HDMI cable 51. In addition, the interface 15 receives a signal inputted from the adapter device 20 via the HDMI cable 51, executes a predetermined interface process including signal conversion and protocol conversion on the received signal, and outputs a resultant signal to the controller 11.

In the source device 10, the controller 11 controls operation executed by the decoder 12. The decoder 12 reproduces contents stored in the DVD 14 using the DVD drive 13, generates video data, audio data, a horizontal synchronization signal and a vertical synchronization signal of a video signal, and auxiliary data, and outputs the generated data and signal to the controller 11. The controller 11 generates an audio and visual signal including a digital video signal, a display format of the digital video signal, a digital audio signal, an output format of the digital audio signal, and the auxiliary data based on the video data, the audio data, the horizontal synchronization signal and vertical synchronization signal of the video signal, and the auxiliary data. In addition, the controller 11 outputs the audio and visual signal to the adapter device 20 via the audio and visual signal lines included in the HDMI cable 51.

Referring to FIG. 2, the adapter device 20 is configured to include a controller 21, an interface 22, a packet processing circuit 23, a wireless transceiver circuit 24 including a high-rate wireless transmitter circuit 24a and a low-rate wireless transceiver circuit 24b, and the antenna 25. The controller 21 controls overall operation executed by the adapter device 20. The interface 22 executes an interface process for interfacing with the source device 10, and outputs a signal and data compliant with the HDMI to the source device 10 via the HDMI cable 51. Further, the interface 22 receives a signal inputted from the source device 10 via the HDMI cable 51, executes a predetermined interface process including signal conversion and protocol conversion on the received signal, and outputs a resultant signal to the packet processing circuit 23.

Under control of the controller 21, the packet processing circuit 23 converts the audio and visual signal inputted from the interface 21 into a digital signal having a predetermined packet format, and outputs the digital signal to the high-rate wireless transmitter circuit 24a. The high-rate wireless transmitter circuit 24a modulates a carrier wave having a high frequency fallen within a millimeter wave band of, for example, about 60 GHz according to the digital signal from the packet processing circuit 23, so as to generate an audio and visual wireless signal including uncompressed video signal and audio signal. Then, the high-rate wireless transmitter circuit 24a wirelessly transmits the audio and visual wireless signal toward the antenna 32 of the adapter device 30 via the antenna 25. Generally speaking, in the wireless communication system, as a carrier wave frequency is higher, a transmission rate can be set to be larger, and a transmission rate of the high-rate wireless transmitter circuit 24a is set to be larger than that of the low-rate wireless transceiver circuit 24b which will be described later.

Further, under control of the controller 21, the packet processing circuit 23 converts various command signals and message signals inputted from the controller 21 into a digital signal having a predetermined packet format, and outputs the digital signal to the low-rate wireless transceiver circuit 24b. The low-rate wireless transceiver circuit 24b modulates a carrier wave having a low frequency such as a millimeter wave or a microwave according to the digital signal from the packet processing circuit 23, so as to generate a wireless signal. Then, the low-rate wireless transceiver circuit 24b wirelessly transmits the wireless signal toward the antenna 32 of the adapter device 30 via the antenna 25.

On the other hand, a wireless signal transmitted from the adapter device 30 is received by the antenna 25, inputted to the low-rate wireless transceiver circuit 24b, and demodulated into a digital signal. The digital signal is outputted to the packet processing circuit 23. The packet processing circuit 23 extracts predetermined command signals and predetermined message signals from the inputted digital signal by a predetermined packet separation process under control of the controller 21, and then outputs extracted command signals and message signal to the controller 21.

As described later in detail, the adapter device 20 is characterized by including the controller 21. The controller 21 wirelessly receives a format notification signal including data on a plurality of video display formats and a plurality of audio output formats stored in the sink device 40 from the adapter device 30. Then, the controller 21 selects one video display format having highest data transmission rate based on the data on the received plurality of video display formats, and selects one audio output format having highest data transmission rate based on the data on the received plurality of audio output formats. The controller 21 reserves a band for wirelessly transmitting a video signal having the selected video display format and an audio signal having the selected audio output format as a band for wirelessly transmitting the audio and video signal from the source device 10.

Referring to FIG. 3, the adapter device 30 is configured to include a controller 31, the antenna 32, a wireless transceiver circuit 33 including a high-rate wireless receiver circuit 33a and a low-rate wireless transceiver circuit 33b, a packet processing circuit 34, and an interface 35. The controller 31 controls overall operation executed by the adapter device 30. The high-rate wireless receiver circuit 33a demodulates an audio and visual wireless signal received via the antenna 32 into a baseband signal using a predetermined digital demodulation format, and outputs the baseband signal to the packet processing circuit 34. In this case, a transmission rate of the high-rate wireless receiver circuit 33a is set to be equal to that of the high-rate wireless receiver circuit 24a. The packet processing circuit 34 extracts an audio and visual signal from the inputted baseband signal by a predetermined packet separation process under control of the controller 31, and then outputs the audio and visual signal to the interface 35.

In addition, the low-rate wireless transceiver circuit 33b demodulates a wireless signal received via the antenna 32 into a baseband signal using a predetermined digital demodulation format, and then outputs the baseband signal to the packet processing circuit 34. In this case, a transmission rate of the low-rate wireless receiver circuit 33b is set to be equal to that of the low-rate wireless receiver circuit 24b. The packet processing circuit 34 extracts predetermined command signals and predetermined message signals from the inputted baseband signal by a predetermined packet separation process based under control of the controller 31, and then outputs the predetermined command signals and message signals to the interface 35.

Further, under control of the controller 31, the packet processing circuit 34 converts various command signals and message signals inputted from the controller 31 into a digital signal having a predetermined packet format, and outputs the digital signal to the low-rate wireless transceiver circuit 33b. The low-rate wireless transceiver circuit 33b modulates a carrier wave having a predetermined frequency according to the digital signal from the packet processing circuit 34, so as to generate a wireless signal, and wirelessly transmits the wireless signal toward the antenna 22 of the adapter device 20 through the antenna 32.

The interface 35 executes an interface process for interfacing with the sink device 40, and outputs a signal and data compliant with the HDMI to the sink device 40 via the HDMI cable 52. In addition, the interface 35 receives a signal inputted from the sink device 40 via the HDMI cable 52, executes a predetermined interface process including signal conversion and protocol conversion on the received signal, and outputs a resultant signal to the packet processing circuit 34.

Referring to FIG. 3, the sink device 40 is configured to include a controller 41, an interface 42, an audio and visual processing circuit 43, the display with the loudspeaker 44, and an EDID memory 45. The controller 41 controls overall operation executed by the sink device 40. The interface 42 executes an interface process for interfacing with the adapter device 30 on a signal inputted from the controller 41, and outputs a signal compliant with the HDMI to the adapter device 30 via the HDMI cable 52. In addition, the interface 42 receives a signal inputted from the adapter device 30 via the HDMI cable 52, executes a predetermined interface process including signal conversion and protocol conversion on the received signal, and outputs a resultant signal to the controller 41.

The controller 41 outputs an inputted audio and visual signal to the audio and visual processing circuit 43. The audio and visual processing circuit 43 separates an inputted audio and visual signal into a video signal and an audio signal, executes a predetermined signal process on the video signal and audio signal, and thereafter, outputs the video signal and audio signal to the display with the loudspeaker 36, so as to display an image and to output a voice. In addition, the EDID memory 45 previously stores therein EDID data on the sink device 40 such as a plurality of video display formats and a plurality of audio output formats. Each of the plurality of video display formats includes data on the sink device 40 such as product information, a manufacturer name, a video coding format (such as RGB, YC_{B}C_{R}4:4:4 or YC_{B}C_{R}4:2:2), a resolution, a field frequency and the number of scanning lines. Each of the plurality of audio output formats includes data on the sink device 40 such as audio output sampling rate, the number of bits per sample, and the number of channels.

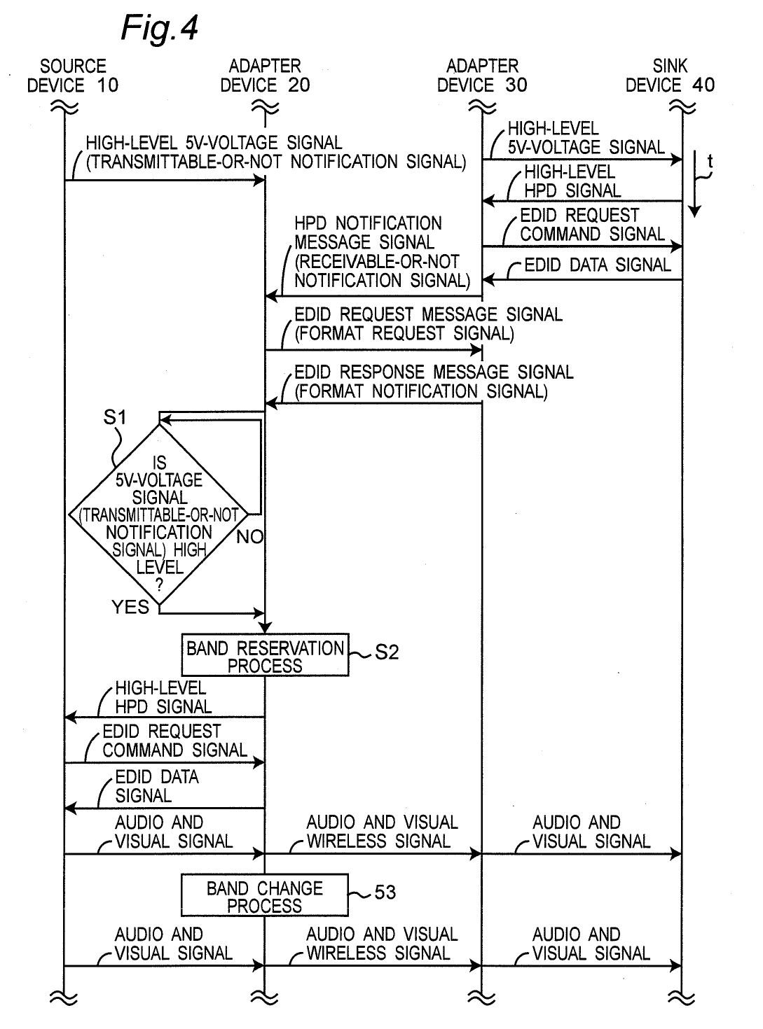

Next, referring to FIGS. 4 to 9, operation executed by the wireless communication system of FIG. 1 will be described. FIG. 4 is a sequence diagram showing an audio and visual signal transmitting process executed by the wireless communication system of FIG. 1. It is to be noted that the controllers 11, 21, 31, and 41 control the operations of the source device 10, the adapter devices 20 and 30, and the sink device 40, respectively, however, the descriptions of the controllers 11, 21, 31, and 41 will be omitted herein.

Referring to FIG. 4, upon detecting that the adapter device 20 in an ON state is connected to the source device 10 via the HDMI cable 51, the source device 10 changes the voltage level of the 5V-voltage signal line included in the HDMI cable 51 from 0V to 5V. By changing the voltage level of the 5V-voltage signal line included in the HDMI cable 51 from 0V to 5V, the source device 10 generate a high-level 5V-voltage signal representing that the source device 10 can transmit a transmitting signal including an audio and visual signal, and outputs the high-level 5V-voltage signal to the adapter device 20 as a transmittable-or-not notification signal.

On the other hand, upon detecting that the sink device 40 in the ON state is connected to the adapter device 30 via the HDMI cable 52, the adapter device 30 changes the voltage level of the 5V-voltage signal line included in the HDMI cable 52 from 0V to 5V. By changing the voltage level of the 5V-voltage signal line included in the HDMI cable 52 from 0V to 5V, the adapter device 30 generates a high-level 5V-voltage signal, and outputs the high-level 5V-voltage signal to the sink device 40. In response to this, the sink device 40 executes a predetermined initialization process. Then, the sink device 40 changes the voltage level of the HPD signal line included in the HDMI cable 52 from the low level to the high level, so as to generate a high-level HPD signal representing that the sink device 40 can receive a transmitting signal including an audio and visual signal, and so as to output the high-level HPD signal to the adapter device 30. In response to this, the adapter device 30 generates an EDID request command signal for requesting the EDID data, and outputs the EDID request command signal to the sink device 40 via the DDC signal line included in the HDMI cable 52. In response to this, the sink device 40 reads out the EDID data including data on a plurality of video display formats and a plurality of audio output formats of the sink device 40 from the EDID memory 45, and outputs an EDID data signal including the read-out EDID data to the adapter device 30 via the DDC signal line included in the HDMI cable 52.

In response to the EDID data signal from the sink device 40, the adapter device 30 generates an HPD notification message signal representing that the sink device 40 can receive a transmitting signal including an audio and visual signal, and wirelessly transmits the HPD notification message signal toward the antenna 25 of the adapter device 20 via the antenna 32 as a receivable-or-not notification signal. In response to this, the adapter device 20 generates an EDID request message signal for requesting the EDID data on the sink device 40, and wirelessly transmits the EDID request message signal toward the antenna 32 of the adapter device 30 via the antenna 25 as a format request signal. In response to this, the adapter device 30 generates an EDID response message signal including the EDID data received from the sink device 40, and wirelessly transmits the EDID response message signal toward the antenna 25 of the adapter device 20 via the antenna 32 as a format notification signal.

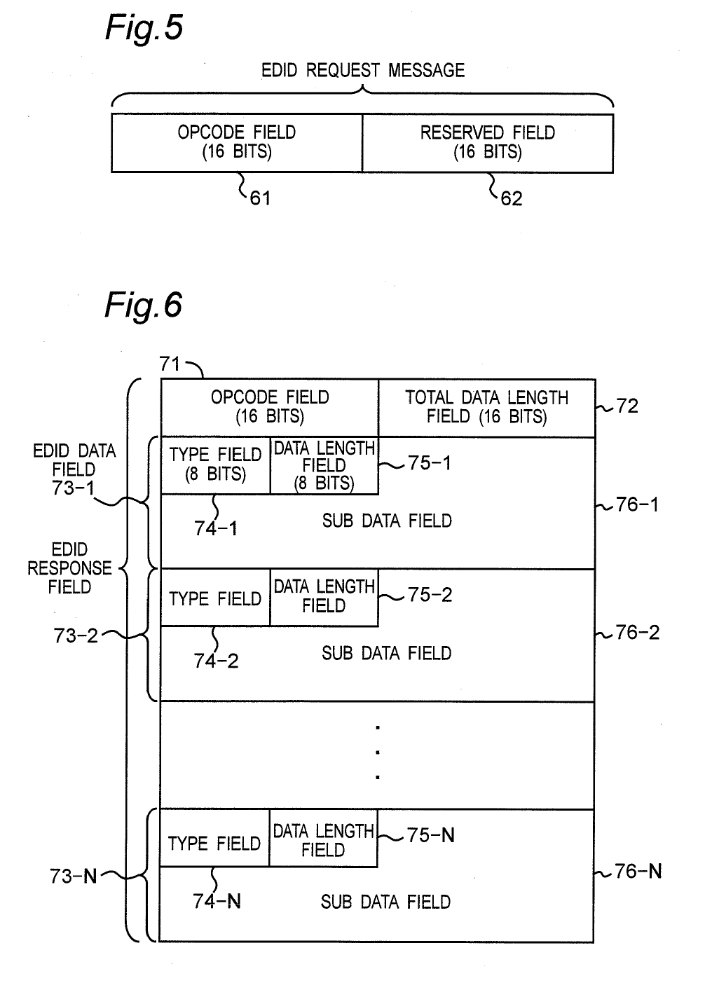

FIG. 5 is a diagram showing an example of a format of an EDID request message included in the EDID request message signal of FIG. 4. The EDID request message includes an opcode field 61 (16 bits) representing a predetermined opcode representing that the message is an EDID request message and a reserved field 62 (16 bits) for further extension.

FIG. 6 is a diagram showing an example of a format of an EDID response message included in the EDID response message signal of FIG. 4. The EDID response message includes an opcode field 71 (16 bits) representing a predetermined opcode representing that the message is an EDID response message, a total data length field 72 (16 bits) representing a total data length of the message, and a plurality of or N EDID data fields 73-1 to 73-N for transmitting EDID data. Each EDID data field 73-n (N=1, 2, . . ., N) includes a sub data field 76-n including the EDID data, a type field 74-n (8 bits) representing a type of the EDID data included in the sub data field 76-n, and a data length field 75-n (8 bits) representing a data length of the sub data field 76-n.

Referring back to FIG. 4, upon wirelessly receiving the EDID response message signal from the adapter device 30, the adapter device 20 determines whether or not the 5V-voltage signal from the source device 10 has the high level at step S1. If NO at step S1, the adapter device 20 repeats the process of step S1, and if YES at step S1, the adapter device 20 executes a band reservation process at step S2. Namely, the adapter device 20 executes the band reservation process at step S2, when the adapter device 20 receives the HPD notification message signal (the receivable-or-not notification signal) representing that the sink device 40 can receive the transmitting signal including the audio and visual signal from the adapter device 30 and receives the 5V-voltage signal (the transmittable-or-not notification signal) representing that the source device 10 can transmit the transmitting signal including the audio and visual signal.

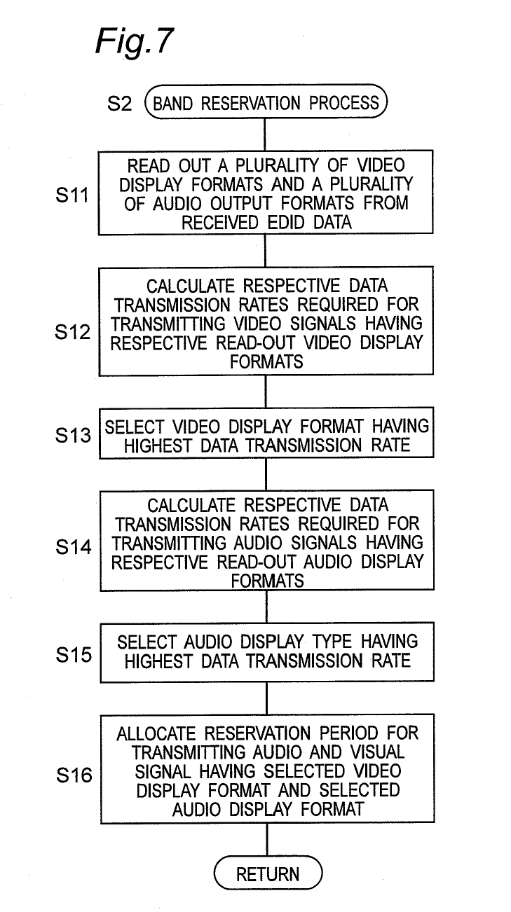

FIG. 7 is a flowchart showing the band reservation process of step S2 of FIG. 4, the band reservation process which is executed by the controller 21 of the adapter device 20 of FIG. 2. First of all, at step S11, the controller 21 reads out a plurality of video display formats and a plurality of audio output formats of the sink device 40 from the EDID data wirelessly received from the adapter device 30. Next, at step S12, the controller 21 calculates respective data transmission rates required for transmitting video signals having the respective read-out video display formats based on the data on the video display formats. Concretely speaking, the controller 21 calculates a product of a frame rate of a video signal, the number of pixels included in one frame, and the number of bits included in one pixel as each data transmission rate. Then, at step S13, the controller 21 selects one video display format having highest data transmission rate from among the read-out video display formats, and the control flow goes to step S14.

Next, at step S14 of FIG. 7, the controller 21 calculates respective data transmission rates required for transmitting audio signals having the respective read-out audio output formats based on the data on the audio output formats. Concretely speaking, the controller 21 calculates a product of a sampling rate of an audio signal, the number of bits per sample, and the number of channels as each data transmission rate. At step S15, the controller 21 selects one audio output format having highest data transmission rate from among the read-out audio output formats. Finally, at step S16, the controller 21 allocates a reservation period for transmitting an audio and visual signal having a selected video display format and a selected audio output format, and the control flow returns to FIG. 4.

For example, the EDID data wirelessly received from the adapter device 30 includes the following formats.
(a) A video display format (referred to as 1080/60p/24 bit hereinafter) having a 1080p image output method (1920 horizontal active pixels, 1080 vertical active pixels, and progressive scanning), a field frequency of 60 Hz, and a 24-bit color expression method.
(b) A video display format (referred to as 1080/60i/24 bit hereinafter) having a 1080i image output method (1920 horizontal active pixels, 1080 vertical active pixels, and interlace scanning), a field frequency of 60 Hz, and a 24-bit color expression method.
(c) A video display format (referred to as 720/60p/24 bit hereinafter) having a 720 p image output method (1280 horizontal active pixels, 720 vertical active pixels, and progressive scanning), a field frequency of 60 Hz, and a 24-bit color expression method.
(d) A video display format (referred to as 480/60p/24 bit hereinafter) having a 480 p image output method (720 horizontal active pixels, 480 vertical active pixels, and progressive scanning), a field frequency of 60 Hz, and a 24-bit color expression method.

In this case, a data transmission rate (1920×1080×60×24=2.985984 Gbps) required for transmitting a video signal having the 1080/60p/24 bit video display format is the highest. Therefore, the adapter device 20 selects the 1080/60p/24 bit, allocates and reserves a reservation period in which the data transmission rate is equal to or higher than 2.985984 Gbps.

Referring back to FIG. 4, upon finishing the band reservation process, the adapter device 20 changes the voltage level of the HPD signal line included in the HDMI cable 51 from the low level to the high level. By changing the voltage level of the HPD signal line included in the HDMI cable 51 from the low level to the high level, the adapter device 20 generates a high-level HPD signal, and outputs the high-level HPD signal to the source device 10. In response to this, the source device 10 generates an EDID request command signal for requesting the EDID data, and outputs the EDID request command signal to the adapter device 20 via the DDC signal line included in the HDMI cable 51. In response to this, the adapter device 20 outputs the EDID data signal to the source device 10 via the DDC signal line included in the HDMI cable 51. In this case, the EDID data signal is received from the adapter device 30, and includes the EDID data including the data on the plurality of video display formats and the plurality of audio output formats of the sink device 40.

Upon receiving the EDID data signal from the adapter device 20, the source device 10 reads out the plurality of video display formats and the plurality of audio output formats of the sink device 40 from the received EDID data, and selects one video display format and one audio output format from among the read-out video display formats and audio output formats, respectively. Further, the source device 10 generates an audio and visual signal having the selected video display format and the selected audio display format, and outputs the audio and visual signal to the adapter device 20 via the audio and visual signal line included in the HDMI cable 51. The adapter device 20 generates an audio and visual wireless signal based on the audio and visual signal from the source device 10, and executes a media access control process for wireless transmission to the adapter device 30 for the allocated reservation period. The adapter device 30 generates an audio and visual signal based on a received audio and visual wireless signal, and outputs the audio and visual signal to the sink device 40 via the audio and visual signal lines included in the HDMI cable 52. The sink device 40 outputs the audio and visual signal from the adapter device 30 to the display with the loudspeaker 30 so as to display an image and output a voice.

On the other hand, upon receiving the audio and visual signal from the source device 10, the adapter device 20 executes a band change process at step S3.

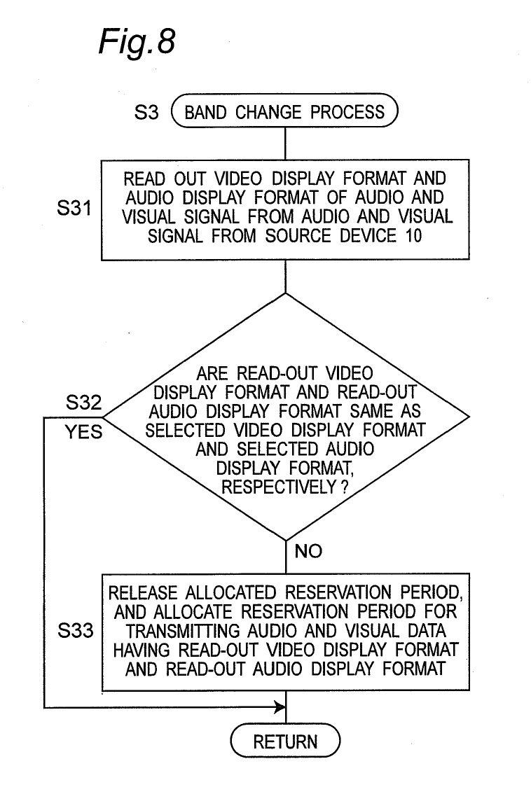

FIG. 8 is a flowchart showing the band change process of step S3 of FIG. 4, the band change process which is executed by the controller 21 of the adapter device 20 of FIG. 2. First of all, at step S31, the controller 21 reads out a video display format and an audio display format of the audio and visual signal, from the audio and visual signal outputted from the source device 10. At step S32, the controller 21 determines whether or not the read-out video display format and the read-out audio display format are the same as the selected video display format and the selected audio display format, respectively. If YES at step S32, the control flow returns to FIG. 4, and if NO at step S32, the control flow goes to step S33. At step S33, the controller 21 releases the reservation period allocated in the above-described band reservation process, allocates and reserves a reservation period for transmitting the audio and video signal having the read-out video display format and the read-out audio display format. Then, the control flow returns to FIG. 4. Referring back to FIG. 4, the adapter device 20 generates an audio and visual wireless signal based on the audio and visual signal from the source device 10, and wirelessly transmits the audio and visual wireless signal to the adapter device 30 for the allocated reservation period.

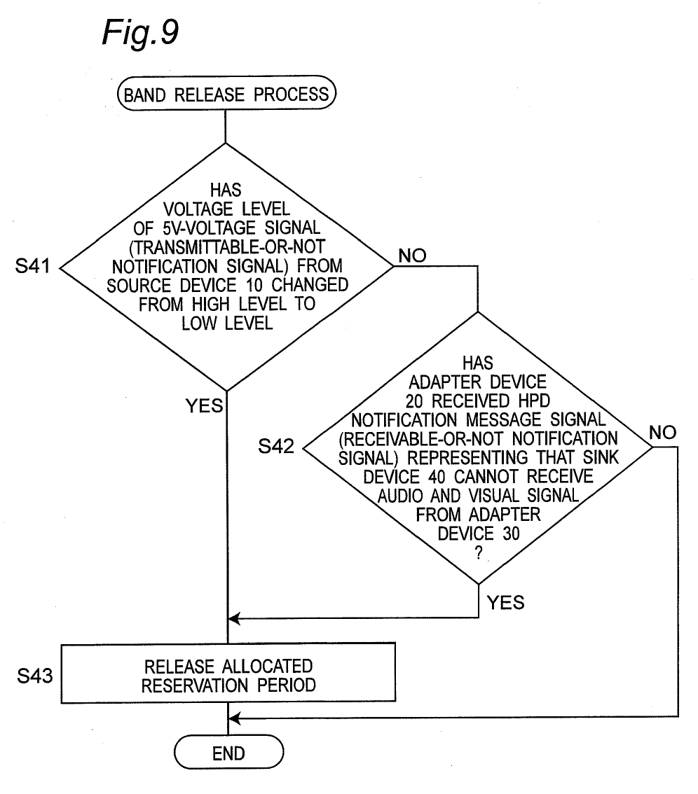

FIG. 9 is a flowchart showing a band release process which is executed by the controller 21 of the adapter device 20 of FIG. 2. After executing the band reservation process of FIG. 7, the controller 21 executes the band release process of FIG. 9 in the background. First of all, at step S41, the controller 21 determines whether or not the voltage level of the 5V-voltage signal from the source device 10 has changed from the high level to the low level. If YES at step S41, the control flow goes to step S43, and if NO at step S41, the control flow goes to step S42. At step S42, the controller 21 determines whether or not the adapter device 20 has received an HPD notification message signal representing that the sink device 40 cannot receive an audio and visual signal from the adapter device 30. If YES at step S42, the control flow goes to the step S43, and if NO at step S42, the controller 21 terminates the band release process. At step S43, the controller 21 release the reservation period allocated in the band reservation process of FIG. 7 to transmit the audio and visual signal. Upon detecting that the voltage level of the HPD signal from the sink device 40 changes from the high level to the low level, the adapter device 30 generates the HPD notification message signal representing that the sink device 40 cannot receive the audio and visual signal, and wirelessly transmits the HPD notification message signal to the adapter device 20.

According to the band release process of FIG. 9, the adapter device 20 releases the reservation period allocated for transmitting the audio and visual signal, when the adapter device 20 receives at least one of the low-level 5V-voltage signal (the transmittable-or-not notification signal) representing that the source device 10 cannot transmit the audio and visual signal and the HPD notification message signal (the receivable-or-not notification signal) representing that the sink device 40 cannot receive the audio and visual signal.

As described above in detail, according to the present embodiment, the adapter device 20 wirelessly receives the format notification signal including the plurality of video display formats and the plurality of audio output formats of the sink device 40 from the adapter device 30, selects the video display format having the highest data transmission rate based on the data on the received video display formats, selects the audio output format having the highest data transmission rate based on the data on the received audio output formats, and reserves the band for wirelessly transmitting the video signal having the selected video display format and the audio signal having the selected audio display format as the band for wirelessly transmitting the audio and visual signal from the source device 10. Therefore, as compared with the prior art, it is possible to wirelessly transmit the audio and visual signal from the source device 10 to the adapter device 30 efficiently.

The adapter device 20 may store the EDID data on the sink device 40 received from the adapter device 30. In this case, when the adapter device 20 receives the HPD notification message signal representing that the sink device 40 can receive the audio and visual signal from the adapter device 30, the adapter device 20 executes the band reservation process of FIG. 7 based on the stored EDID data without transmitting the EDID request message signal to the adapter device 30 and without receiving the EDID response message signal from the adapter device 30 (See FIG. 4).

### Second Embodiment

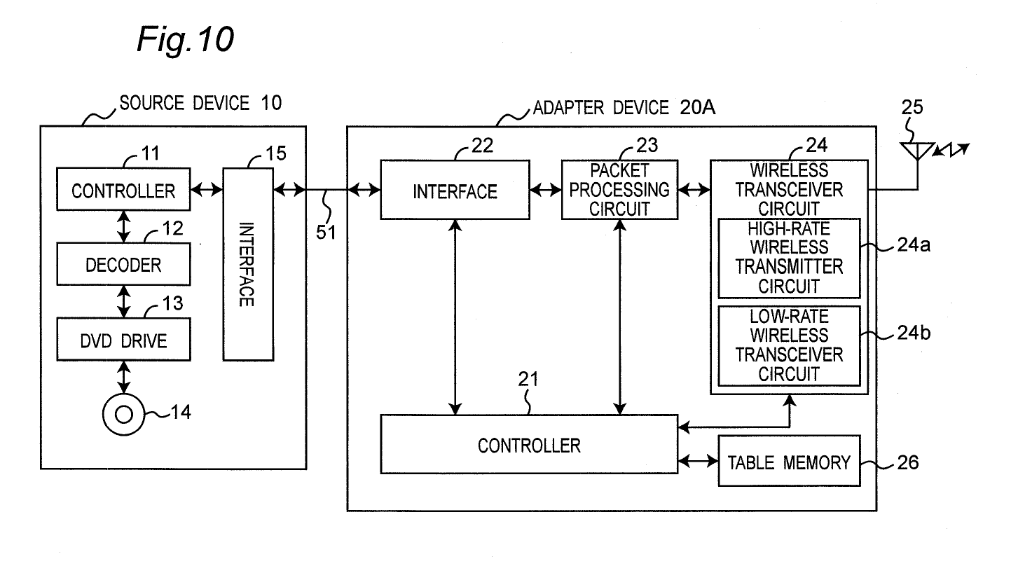

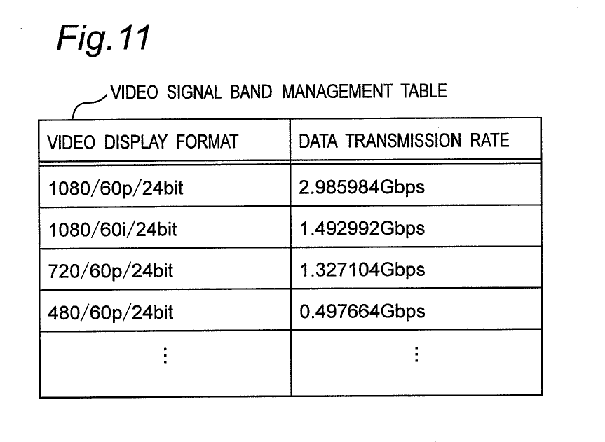

FIG. 10 is a block diagram showing respective configurations of an adapter device 20A and a source device 10 (referred to as an adapter device 20A hereinafter) according to a second embodiment of the present invention. In addition, FIG. 11 is a table showing a video signal band management table stored in a table memory 26 of FIG. 10.

As compared with the adapter device 20 according to the first embodiment, the adapter device 20A according to the second embodiment further includes the table memory 26 for storing therein the video signal band management table and an audio signal band management table. The video signal band management table stores therein the video display formats of the sink device 40 and the data transmission rates for wirelessly transmitting video signals having the video display formats with establishing a correspondence between the video display formats and the data transmission rates for wirelessly transmitting the video signals having the video display formats. The audio signal band management table stores therein audio output formats of the sink device 40 and the data transmission rates for wirelessly transmitting audio signals having the audio output formats with establishing a correspondence between the audio output formats and the data transmission rates for wirelessly transmitting the audio signals having the audio output formats. The controller 21 is characterized by selecting one video display format having the highest data transmission rate with reference to the video signal band management table, and selecting one audio output format having the highest data transmission rate with reference to the audio signal band management table.

As shown in FIG. 11, the video signal band management table stores therein the video display formats of the sink device 40 and the data transmission rates for wirelessly transmitting the video signals having the video display formats with establishing a correspondence between the video display formats and the data transmission rates for wirelessly transmitting the video signals having the video display formats.

Next, a band reservation process executed by the controller 21 of the adapter device 20A will be described. Upon wirelessly receiving the EDID response message signal (See FIG. 4) from the adapter device 30, the adapter device 20A reads out the plurality of video display formats and the plurality of audio output formats of the sink device 40 from the EDID data wirelessly received from the adapter device 30 when the 5V-voltage signal from the source device 10 has the high level. The adapter device 20A selects one video display format having the highest data transmission rate from among the read-out video display formats with reference to the video signal management table. Further, the adapter device 20A decides data transmission rates required for transmitting video signals having the read-out audio output formats, respectively, with reference to the audio signal band management table, and selects one audio output format having the highest transmission rate from among the read-out audio output formats. Further, the adapter device 20A allocates a reservation period for transmitting an audio and visual signal having a selected video display format and a selected audio output format.

Therefore, according to the second embodiment, it is possible to reduce time required for the band reservation process for allocating the reservation period for wirelessly transmitting the audio and visual signal outputted from the source device 10 as compared with the first embodiment.

The table memory 26 may previously store a video signal band management table storing therein the video display formats of the sink device 40 and priorities representing the data transmission rates for wirelessly transmitting the video signals having the video display formats with establishing a correspondence between the video display formats and the priorities. In this case, the controller 21 of the adapter device 20 may select a video display format having the highest priority with reference to the video signal band management table as the video display format having the highest data transmission rate from among the plurality of video display formats.

In addition, the table memory 26 may previously store an audio signal band management table storing therein the audio output formats of the sink device 40 and priorities representing the data transmission rates for wirelessly transmitting the video signals having the audio output formats with establishing a correspondence between the audio output formats and the data transmission rates for wirelessly transmitting the audio signals having the audio output formats. In this case, the controller 21 of the adapter device 20 may select an audio output format having the highest priority with reference to the audio signal band management table as the audio output format having the highest data transmission rate from among the plurality of video display formats.

### Modified Embodiment of Second Embodiment

As compared with the second embodiment, a modified embodiment of the second embodiment is characterized in that the video signal band management table further stores therein the video display formats of the sink device 40 and band reservation parameters for reserving bands for wirelessly transmitting the video signals having the video display formats with establishing a correspondence between the video display formats and the band reservation parameters. The modified embodiment of the second embodiment is further characterized in that the controller 21 selects one video display format having the highest data transmission rate, and reserves the band for wirelessly transmitting the video signal having the selected video display format as the band for wirelessly transmitting the video signal included in the audio and visual signal from the source device 10, using the band reservation parameter corresponding to the selected video display format with reference to the video signal band management table.

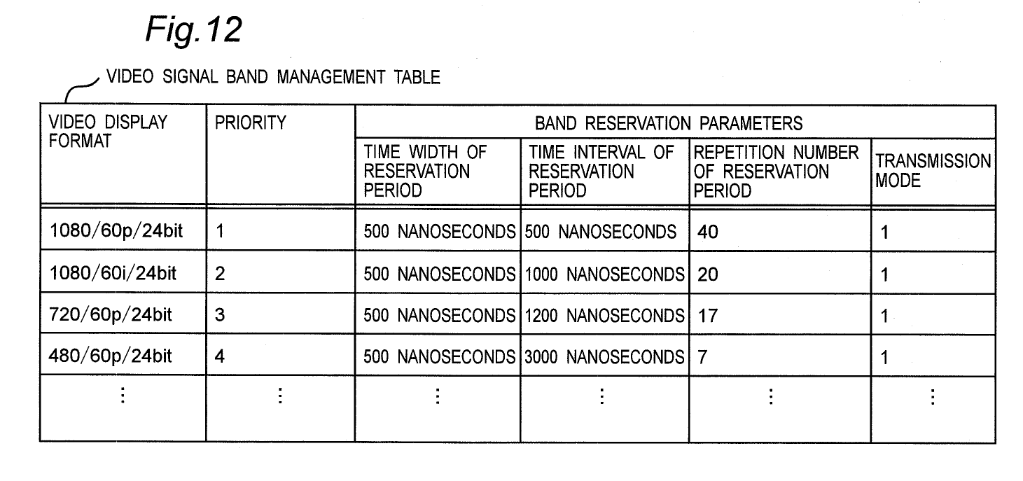

FIG. 12 is a table showing the video signal band management table according to the modified embodiment of the second embodiment of the present invention. As shown in FIG. 12, the video signal band management table according to the modified embodiment of the second embodiment includes a relation among the video display formats, selection priorities representing data transmission rates corresponding to the video display formats, and the band reservation parameters for reserving bands required for transmitting the video signals having the video display formats, respectively.

In this case, the band for wirelessly transmitting the video signal included in the audio and visual signal from the source device 10 includes repetition of a plurality of reservation periods. Each of the band reservation parameters includes a time width of each of the reservation periods, a time interval of each of the reservation period, a repetition number of the reservation periods, and a transmission mode. The transmission mode includes a transmission mode 1 for transmitting a video and audio signal using the high-rate wireless transmitter circuit 24a and a transmission mode 2 for transmitting the audio and visual signal using the low-rate wireless transceiver circuit 24b.

Next, a band reservation process executed by the controller 21 of the adapter device 20A will be described. Upon wirelessly receiving the EDID response message signal (See FIG. 4) from the adapter device 30, the adapter device 20A selects a video display format having the highest priority with reference to the video signal band management table when the 5V-voltage signal from the source device 10 has the high level. Then, the adapter device 20A allocates a reservation period for transmitting a video signal having a selected video display format based on the band reservation parameters with reference to the video signal management table. Further, the adapter device 20A transmits the video signal included in the audio and visual signal from the source device 10 toward the adapter device 30 for a reserved reservation period.

Therefore, according to the modified embodiment of the second embodiment, it is possible to reduce time required for the band reservation process for allocating the reservation period for wirelessly transmitting the video signal included in the audio and visual signal from the source device 10 as compared with the second embodiment. It is to be noted that the band reservation parameters are not limited to those of FIG. 12.

In the respective embodiments and the modified embodiment, the video display formats of the sink device 40 are 1080/60 p/24 bit, 1080/60 i/24 bit, 720/60 p/24 bit and 480 p. However, the present invention is not limited to these, and the video display formats of the sink device 40 may be other video display formats.

In addition, in the respective embodiments and the modified embodiment, the adapter device 20 or 20A wirelessly transmits the EDID request message signal for requesting the EDID data on the sink device 40 to the adapter device 30. In addition, in response to this, the adapter device 30 wirelessly transmits the EDID response message signal including the EDID data on the sink device 40 to the adapter device 20 or 20A. However, the present invention is not limited to this. The adapter device 20 or 20A may wirelessly transmit a format request signal for requesting data on the plurality of video display formats and the plurality of audio output formats of the sink device 40, to the adapter device 30. In this case, in response to this, the sink device 40 wirelessly transmits a format notification signal including the data on the plurality of video display formats and the plurality of audio output formats of the sink device 40 to the adapter device 20 or 20A.

Further, in the respective embodiments and the modified embodiment, the audio and visual wireless signal including the audio and visual signal is transmitted using the high-rate wireless transmitter circuit 24a and the high-rate wireless receiver circuit 24b, and the wireless signal including the message signal and the command signal is transmitted using the low-rate wireless transceiver circuits 24b and 33b. However, the present invention is not limited to this. A wireless signal including the video signal may be transmitted using the high-rate wireless transmitter circuit 24a and the high-rate wireless receiver circuit 24b, and the wireless signal including the audio signal, message signal and the command signal may be transmitted and received using the low-rate wireless transceiver circuits 24b and 33b. In addition, a wireless signal including the audio and visual signal, the message signal, and the command signal may be transmitted and received using the high-rate wireless transmitter circuit 24a and the high-rate wireless receiver circuit 24b. Further, antennas may be provided for the high-rate wireless transmitter circuit 24a and the high-rate wireless receiver circuit 24b, respectively, and antennas may be provided for the low-rate wireless transceiver circuits 24b and 33b, respectively.

In the band release process of FIG. 9, the adapter device 20 releases the reservation period allocated for transmitting the audio and visual signal when the adapter device 20 receives at least one of the low-level 5V-voltage signal (the transmittable-or-not notification signal) representing that the source device 10 cannot transmit the audio and visual signal and the HPD notification message signal (the receivable-or-not notification signal) representing that the sink device 40 cannot receive the audio and visual signal. However, the present invention is not limited to this. The adapter device 20 may release the allocated reservation period upon receiving the low-level 5V-voltage signal representing that the source device 10 cannot transmit the audio and visual signal. In addition, the adapter device 20 may release the allocated reservation period upon receiving the HPD notification message signal (the receivable-or-not notification signal) representing that the sink device 40 cannot receive the audio and visual signal.

Still further, in the respective embodiments and the modified embodiment, the source device 10 is the DVD player. However, the present invention is not limited to this. The source device 10 may be a source device such as a set-top box or a DVD recording and reproducing device for outputting an audio and visual signal. In addition, in the respective embodiments, the sink device 40 is the PDP device. However, the present invention is not limited to this. The sink device 40 may be a sink device such as a projector device with a loudspeaker for outputting a video signal to a display so as to display the video signal and for outputting an audio signal to a loudspeaker.

In addition, in the respective embodiments and the modified embodiment, the adapter device 20 or 20A allocates and reserves the reservation period having the data transmission rate required for transmitting the audio and visual signal (step S16 of FIG. 7 and step S33 of FIG. 8). However, the present invention is not limited to this. The adapter device 20 or 20A may allocate and reserve a frequency band having the data transmission rate required for transmitting the audio and visual signal.

Further, in the respective embodiments and the modified embodiment, the source device 10 is the signal source device for transmitting and receiving signals compliant with the HDMI, and the sink device 40 is the signal sink device for transmitting and receiving the signals compliant with the HDMI. However, the present invention is not limited to this. The source device 10 may be a signal source device for transmitting and receiving signals compliant with the DVI, and the sink device 40 may be a signal sink device for transmitting and receiving the signals compliant with the DVI.

In this case, the adapter device 20 is connected to the source device 10 via a DVI cable, and wirelessly transmits a transmitting signal including a video signal from the source device 10 in a predetermined band. In addition, the adapter device 30 is connected to the sink device 40 via a DVI cable, wirelessly receives the transmitting signal, and outputs the video signal included in the wirelessly received transmitting signal to display means of the sink device 40 so as to display the video signal. In addition, the controller 21 of the adapter device 20 wirelessly receives a format notification signal including a plurality of video display formats of the sink device 40 from the adapter device 30, selects one video display format having the highest data transmission rate based on data on the video display formats, and reserves a band for wirelessly transmitting a video signal having the selected video display format as the predetermined band.

### INDUSTRIAL APPLICABILITY

As described above in detail, according to the adapter device for use in the source device and the method of controlling the adapter device for use in the source device according to the present invention, the format notification signal including the data on the plurality of video display formats stored in the sink device is wirelessly received from the adapter device for the sink device, one video display format having the highest data transmission rate is selected based on the data on the plurality of video display formats, and the band for wirelessly transmitting the video signal having the selected video display format is reserved as the predetermined band. Therefore, it is possible to wirelessly transmit the video signal received from the source device more efficiently as compared with the prior art.

### REFERENCE SIGNS LIST

10 . . . Source Device,

11, 21, 31, and 41 . . . Controller,

12 . . . Decoder,

13 . . . DVD Drive,

14 . . . DVD,

15, 22, 35, and 42 . . . Interface,

20 and 20A . . . Adapter Device for Source Device,

30 . . . Adapter Device for Sink Device,

23 and 34 . . . Packet Processing Circuit,

24 and 33 . . . Wireless Transceiver Circuit,

24a . . . High-Rate Wireless Transmitter Circuit,

24b and 33b . . . Low-Rate Wireless Transceiver Circuit,

25 and 32 . . . Antenna,

26 . . . Table Memory,

33a . . . High-Rate Wireless Transmitter Circuit,

43 . . . Audio and Visual Processing Circuit,

44 . . . Display With Loudspeaker,

45 . . . EDID Memory,

51 and 52 . . . HDMI Cable.

1-22. (canceled)

23. An adapter device for a source device for use in a wireless communication system, the wireless communication system comprising:
the adapter device for the source device wirely connected to the source device, the adapter device for the source device wirelessly transmitting a transmitting signal including a video signal from the source device in a predetermined band; and
an adapter device for a sink device wirely connected to the sink device, the sink device storing therein data on a plurality of video display formats, the adapter device for the sink device wirelessly receiving the transmitting signal, and outputting the video signal included in a wirelessly received transmitting signal to a display device of the sink device so as to display the video signal,
wherein the adapter device for the source device comprises a controller for wirelessly receiving a format notification signal including the data on the plurality of video display formats of the sink device from the adapter device for the sink device, the controller selecting one video display format having highest data transmission rate based on the data on the plurality of video display formats, and the controller reserving a band for wirelessly transmitting a video signal having a selected video display format as the predetermined band.

24. The adapter device for the source device according to claim 23,
wherein the controller calculates data transmission rates for wirelessly transmitting video signals having the plurality of video display formats based on the data on the video display formats, respectively, and selects the video display format having the highest data transmission rate based on calculated data transmission rates.

25. The adapter device for the source device according to claim 23, further comprising a storage device for previously storing therein a band management table for storing therein the video display formats and the data transmission rates for wirelessly transmitting the video signals having the video display formats with establishing a correspondence between the video display formats and the data transmission rates for wirelessly transmitting the video signals having the video display formats,
wherein the controller selects the video display format having the highest data transmission rate with reference to the band management table.

26. The adapter device for the source device according to claim 23, further comprising a storage device for previously storing therein a band management table for storing therein the video display formats and priorities representing the data transmission rates for wirelessly transmitting the video signals having the video display formats with establishing a correspondence between the video display formats and the priorities,
wherein the controller selects the video display format having highest priority as the video display format having the highest data transmission rate with reference to the band management table.

27. The adapter device for the source device according to claim 26,
wherein the band management table further stores therein band reservation parameters for reserving bands for wirelessly transmitting the video signals having the video display formats with establishing a correspondence between the video display formats and the band reservation parameters, and
wherein the controller reserves the band for wirelessly transmitting the video signal having the selected video display format as the predetermined band using a band reservation parameter corresponding to the selected video display format with reference to the band management table.

28. The adapter device for the source device according to claim 27,
wherein the band for wirelessly transmitting the video signal having the selected video display format includes repetition of a plurality of reservation periods, and
wherein each of the band reservation parameters includes at least a time width of each of the reservation periods, a time interval of each of the reservation periods, and a repetition number of the reservation periods.

29. The adapter device for the source device according to claim 23,
wherein the transmitting signal includes the video display format of the video signal included in the transmitting signal, and
wherein, when a video display format of the video signal included in the transmitting signal is different from the selected video display format, the controller releases a reserved predetermined band, and reserves a band for wirelessly transmitting the video signal included in the transmitting signal as the predetermined band.

30. The adapter device for the source device according to claim 23,
wherein the format notification signal includes EDID (Extended Display Identification Data) data including the data on the plurality of video display formats of the sink device.

31. The adapter device for the source device according to claim 23,
wherein the transmitting signal further includes an audio signal from the source device,
wherein the sink device further stores therein data on a plurality of audio output formats,
wherein the adapter device for the sink device outputs the audio signal included in the transmitting signal to the sink device,
wherein the format notification signal further includes the data on the plurality of audio output formats of the sink device, and
wherein the controller selects one audio output format having highest data transmission rate based on the data on the plurality of audio output formats, and reserves a band for wirelessly transmitting the video signal having the selected video display format and an audio signal having the selected audio output format as the predetermined band.

32. The adapter device for the source device according to claim 23,
wherein, upon receiving a transmittable-or-not notification signal representing that the source device can transmit the transmitting signal from the source device, the controller reserves the predetermined band.

33. The adapter device for the source device according to claim 23,
wherein, upon wirelessly receiving a receivable-or-not notification signal representing that the sink device can receive the transmitting signal from the adapter device for the sink device, the controller reserves the predetermined band.

34. The adapter device for the source device according to claim 23,
wherein, upon receiving a transmittable-or-not notification signal representing that the source device cannot transmit the transmitting signal from the source device, the controller releases the reserved predetermined band.

35. The adapter device for the source device according to claim 23,
wherein, upon wirelessly receiving a receivable-or-not notification signal representing that the sink device cannot receive the transmitting signal from the adapter device for the sink device, the controller releases the reserved predetermined band.

36. A method of controlling an adapter device for a source device for use in a wireless communication system, the wireless communication system comprising:
the adapter device for the source device wirely connected to the source device, the adapter device for the source device wirelessly transmitting a transmitting signal including a video signal from the source device in a predetermined band; and
an adapter device for a sink device wirely connected to the sink device, the sink device storing therein data on a plurality of video display formats, the adapter device for the sink device wirelessly receiving the transmitting signal, and outputting the video signal included in a wirelessly received transmitting signal to a display device of the sink device so as to display the video signal,
wherein the method includes a control step of wirelessly receiving a format notification signal including the data on the plurality of video display formats of the sink device from the adapter device for the sink device, selecting one video display format having highest data transmission rate based on the data on the plurality of video display formats, and reserving a band for wirelessly transmitting a video signal having a selected video display format as the predetermined band.

37. The method of controlling the adapter device for the source device according to claim 36,
wherein the control step includes calculating data transmission rates for wirelessly transmitting video signals having the plurality of video display formats based on the data on the video display formats, respectively, and selecting the video display format having the highest data transmission rate based on calculated data transmission rates.

38. The method of controlling the adapter device for the source device according to claim 36, further including a step of previously storing a band management table in a storage device, the band management table storing the video display formats and the data transmission rates for wirelessly transmitting the video signals having the video display formats with establishing a correspondence between the video display formats and the data transmission rates for wirelessly transmitting the video signals having the video display formats,
wherein the control step includes selecting the video display format having the highest data transmission rate with reference to the band management table.

39. The method of controlling the adapter device for the source device according to claim 36, further including a step of previously storing a band management table in a storage device, the band management table storing the video display formats and priorities representing the data transmission rates for wirelessly transmitting the video signals having the video display formats with establishing a correspondence between the video display formats and the priorities,
wherein the control step includes selecting the video display format having highest priority as the video display format having the highest data transmission rate with reference to the band management table.

40. The method of controlling the adapter device for the source device according to claim 39,
wherein the band management table further stores therein band reservation parameters for reserving bands for wirelessly transmitting the video signals having the video display formats with establishing a correspondence between the video display formats and the band reservation parameters, and
wherein the control step includes reserving the band for wirelessly transmitting the video signal having the selected video display format as the predetermined band using a band reservation parameter corresponding to the selected video display format with reference to the band management table.

41. The method of controlling the adapter device for the source device according to claim 40,
wherein the band for wirelessly transmitting the video signal having the selected video display format includes repetition of a plurality of reservation periods, and
wherein each of the band reservation parameters includes at least a time width of each of the reservation periods, a time interval of each of the reservation periods, and a repetition number of the reservation periods.

42. The method of controlling the adapter device for the source device according to claim 36,
wherein the transmitting signal includes the video display format of the video signal included in the transmitting signal, and
wherein the control step includes releasing a reserved predetermined band, and reserving a band for wirelessly transmitting the video signal included in the transmitting signal as the predetermined band, when a video display format of the video signal included in the transmitting signal is different from the selected video display format.

43. The method of controlling the adapter device for the source device according to claim 36,
wherein the format notification signal includes EDID data including the data on the plurality of video display formats of the sink device.

44. The method of controlling the adapter device for the source device according to claim 36,
wherein the transmitting signal further includes an audio signal from the source device,
wherein the sink device further stores therein data on a plurality of audio output formats,
wherein the adapter device for the sink device outputs the audio signal included in the transmitting signal to the sink device,
wherein the format notification signal further includes the data on the plurality of audio output formats of the sink device, and
wherein the control step includes selecting one audio output format having highest data transmission rate based on the data on the plurality of audio output formats, and reserving a band for wirelessly transmitting the video signal having the selected video display format and an audio signal having the selected audio output format as the predetermined band.
